(19) United States
(12) Patent Application Publication
(10) Pub. No.: US 2019/0194506 A1
(43) Pub. Date: Jun. 27, 2019

(54) LOW TEMPERATURE ADHESIVE BOND MATERIAL

(71) Applicant: International Business Machines Corporation, Armonk, NY (US)

(72) Inventors: Jeffrey D. Gelorme, Burlington, CT (US); Li-Wen Hung, Mahopac, NY (US); John U. Knickerbocker, Yorktown Heights, NY (US)

(21) Appl. No.: 15/852,540

(22) Filed: Dec. 22, 2017

(51) Int. Cl. C09J 133/12; C09J 171/08; C08F 2/18; C08K 3/04; C09J 11/04; C08L 33/12

(52) U.S. Cl. CPC C09J 133/12; C09J 171/08; C08F 2/18; C08K 3/04; C09J 2203/326; C08L 33/12; C08L 2203/20; C09J 2400/10; C09J 11/04

(57) ABSTRACT

A device wafer is bonded to a handle by a low temperature adhesive bond material that includes a suspended polymer with glass transition temperature greater than room temperature and a diluent polymer that is curable to provide a thermoset polymer upon exposure to ultraviolet radiation, x-ray radiation and/or thermal treatments at low temperature. The suspended polymer and the diluent polymer are mixed to a consistency such that before curing of the diluent polymer the low temperature adhesive bond material exhibits adhesion strength less than 10 Newtons per square centimeter (N/cm²), and after curing of the diluent polymer the low temperature adhesive bond material exhibits adhesion strength not less than about 40 N/cm².

### BACKGROUND

The present disclosure relates to the electrical, electronic, and computer arts, and, more particularly, to the handling of small die and electronic components used to fabricate electronic devices.

With shrinking dimensions of various integrated circuit components, transistors such as FETs have experienced dramatic improvements in both performance and power consumption. These improvements may be largely attributed to the reduction in dimensions of components used therein, which in general translate into reduced capacitance, resistance, and increased through-put current from the transistors. Miniaturization has provided benefits to mobile devices such as smart phones, implantable devices, IoT (internet of things) devices, as well as other applications. As the size of circuit components and electronic devices decreases, challenges arise in the assembly of such components.

In manufacturing semiconductor devices such as integrated circuits, it is desirable to work with device wafers that may be as thin as about 10 micrometers (um) to about 50 um in thickness. Except at very small diameters, such thin wafers are difficult to handle without breakage. Accordingly, for bulk manufacture (in excess of a few chips at a time) the device wafers can be bonded onto “handles”. Bonding includes attaching a device wafer, which is to become a layer in a final electronic device structure, to a handle so that it can be processed, for example, with wiring, pads, and/or joining metallurgy. Handles may be rigid wafers or panels of significantly greater thickness than the device wafers, typically in excess of about 700 um, or may be tough and flexible tapes of thickness of about 50 um to over 75 um and may be used in roll to roll form with or without planar or vacuum support. Handles are used during processing, assembly, and/or integration of die, multiple die, component, multiple components and/or package, flexible packages, antenna, batteries, capacitors, super capacitors, energy scavenging devices, displays, light emitting diodes (LED), sensors, photo detectors, lasers or other energy solutions, sealing and hermitic encapsulation solutions, or other elements of systems or subsystems. Once semiconductor fabrication has been completed, the device wafers then are debonded from the handle wafers in order to permit mounting the device wafers onto a printed circuit board or other substrate. Debonding involves removing the processed device wafer from the substrate or handle so that the processed device wafer may be employed within an electronic device. Wafer bonding and debonding are important technologies for implementing the fabrication of semiconductor devices, photovoltaic devices, and electrical devices of micron and nanoscale.

Polyimide adhesives and deep ultraviolet excimer lasers are becoming the norm for bonding and debonding device wafers. Typically, a polyimide adhesive is used as the bonding agent and a glass substrate that matches the device wafer's coefficient of thermal expansion is used as the handle wafer. One common polyimide adhesive is HD3007, a product from HD Microsystems, Inc. HD3007 is supplied as a polyamic acid precursor, which is applied to the device wafer early in the manufacturing process. The polyamic acid requires a cure temperature of about 300-400 degrees Celsius (° C.), and once it has been cured, the polyimide has a flow temperature usually greater than 300° C. for softening and bonding to the handle wafer. However, many of the manufacturing steps are done near room temperature. Heating and cooling time, and available oven space, therefore add significant delay to the manufacturing process. Additionally, thermal transients in the device wafer and integration of die, wafers, packages and/or components consisting of different materials or using different materials, fixtures, handlers and structures can cause warping, reduced yield or other damage. Furthermore, removal of polyimide adhesive requires long soak times in strong hot solvents such as NMP or DMSO. Similarly, alternate adhesives compositions that are designed for compatibility of processing and/or integration in the 180° C. to 300° C. temperature range can also have disadvantages in throughput, warping, reduced yield, solder reflow, excessive intermetallic formation for interconnections or other damages.

The industry has tried to alleviate the problems of polyimide adhesives by using other materials such as poly(meth)acrylates that do not require such high temperatures to cure or flow, and that require less aggressive solvents for removal. For example, TOK and Brewer Science supply poly(meth)acrylates that are useful in semiconductor processing. However, these materials generally flow excessively at temperatures above about 170° C. This low viscosity is believed to cause “squeeze out” at bonding temperatures of about 200 to 210° C. Squeeze out can lead to inaccuracies during subsequent manufacturing steps due to a loose bond between the device wafer and the handle wafer.

### SUMMARY

Principles of the invention provide techniques for a low temperature adhesive bond material. In one aspect, a device wafer is bonded to a handle by a low temperature adhesive bond material that includes a suspended polymer with glass transition temperature greater than room temperature and a diluent polymer that is curable to provide a thermoset polymer upon exposure to ultraviolet radiation, x-ray radiation and/or thermal treatments at low temperature. The suspended polymer and the diluent polymer are mixed to a consistency such that before curing of the diluent polymer the low temperature adhesive bond material exhibits adhesion strength less than 10 Newtons per square centimeter (N/cm²), and after curing of the diluent polymer the low temperature adhesive bond material exhibits adhesion strength not less than about 40 N/cm².

In another aspect, the low temperature adhesive bond material composition is provided.

In another aspect, an exemplary method includes coating a carrying surface of one of the device wafer or a handle with a low temperature adhesive bond material that includes a suspended polymer that has a glass transition temperature (Tg) greater than room temperature and a diluent polymer that is liquid at room temperature and is curable to provide a thermoset polymer upon exposure to ultraviolet radiation, x-ray radiation and/or thermal treatments at low temperature. The suspended polymer and the diluent polymer are mixed to a consistency such that before curing of the diluent polymer the low temperature adhesive bond material exhibits adhesion strength less than 10 Newtons per square centimeter (N/cm²), and after curing of the diluent polymer the low temperature adhesive bond material exhibits adhesion strength not less than about 40 N/cm². The method further includes, while holding the coated carrying surface against the carrying surface of the other of the device wafer or the handle, bonding the device wafer to the handle by irradiating the coated carrying surface with visible light, ultraviolet, or x-ray radiation at low temperature to cure the diluent polymer.

In view of the foregoing, techniques of the present invention can provide substantial beneficial technical effects. For example, one or more embodiments provide one or more of:

Handling of small, thin dies without damage and in a cost efficient manner.

Room temperature (less than 25°) or low temperature (preferably less than 80° C.) adhesive cure.

Low pressure adhesion of device wafer to handle.

Compatibility of materials, structures and processes to support maximum use temperatures such as from near 0 K to about 300° C. for portions or all of the processing steps. Usability to lower temperature may be important for storage of biologic materials and also for applications such as use of lower temperature indium alloys for quantum computing, etc.

Compatibility of materials, structures and processes to support maximum use temperatures such as from near 0 K to about 160° C. for portions or all of the processing steps.

Compatibility of materials, structures and processes to support maximum use temperatures such as from near 0° C. to about 100° C. for portions or all of the processing steps.

Compatibility of materials, structures and processes to support maximum use temperatures such as from near 0° C. to about 60° C. for portions or all of the processing steps.

Compatibility of materials, structures and processes to targeted single solder alloys or multi temperature tier solder hierarchy limits such as with indium based solder alloys, tin based solder alloys, lead based solder alloys and/or other solder alloys and/or adhesive compositions or metal interconnections.

Low temperature or room temperature debonding.

Higher rates of production compared to conventional high temperature bonding materials.

Cost efficient production of semiconductor devices incorporating biologics.

Compatibility with area array wafer or panel based production, roll-to-roll production or other volume manufacture of semiconductor devices and/electronic systems.

Ability to integrate heterogeneous components and materials of differing coefficient of thermal expansion with minimal or no stress due to low temperature or minimal temperature excursions.

Ability to integrate heterogeneous materials including rigid or high modulus materials or components with flexible or low modulus materials and components using the materials, tools, and methods described as a portion of this invention.

Low stress adhesive film.

Reduced wafer warpage due to bonding/debonding.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a chemical structure of a polymethylmethacrylate polymer usable as a suspended polymer in a low temperature adhesive bond material, according to an exemplary embodiment of the invention;

FIG. 2 depicts chemical structures of acrylate and methacrylate polymers usable as a diluent polymer in a low temperature adhesive bond material, according to an exemplary embodiment of the invention;

FIG. 3 depicts a side view of a device wafer bonded to a handle by a layer of low temperature adhesive bond material incorporating a release agent;

FIG. 4 depicts a side view of a device wafer bonded to a handle by a layer of low temperature adhesive bond material and a layer of release agent; and

FIG. 5 depicts a side view of a device wafer bonded onto a tape of low temperature adhesive bond material.

### DETAILED DESCRIPTION

Certain emerging applications for semiconductor devices include combining such devices with biologic materials such as bioassay materials or pharmaceuticals. Such biologic materials degrade at temperatures above room temperature, for example, at temperatures above about 100° C. This consideration, combined with the relatively high temperatures of conventional wafer bonding and debonding processes, has so far prevented bulk manufacture of semiconductor devices that incorporate some classes of organic materials. Accordingly, it is desirable to provide for low temperature wafer bonding and debonding processes that will enable the bulk manufacture of semiconductor devices that incorporate biologic materials.

“Room temperature” in this case indicates temperatures within the range of about 0 degrees Celsius (° C.) to about 35° C. although 20° C. to about 25° C. may be typical. “Low temperature” in this case indicates temperatures that do not cause degradation of biologic materials, e.g., less than about 80° C. “Intermediate temperature” in this case indicates temperatures that do not cause degradation of certain solder compositions, integrated components or systems, materials and/or structures, e.g., less than about 160° C.

“X-ray” in this case indicates wavelengths between 0.01 and 10 nm. “Ultraviolet” in this case indicates wavelengths between 10 and 400 nanometers (nm). “Infrared” in this case indicates wavelengths between 700 nm and 3 millimeter (mm). “Visible light” in this case indicates wavelengths between ultraviolet and infrared.

Generally, embodiments of the invention provide a low temperature adhesive bond material that is curable by exposure to radiation at low temperature. Exemplary wavelengths of radiation for curing the bond material include x-ray, ultraviolet, or visible light. In one or more embodiments, the bond material is not curable at room temperature, but is curable at temperatures above room temperature or in combination with radiation. It is preferred that the bond adhesive material is not overly tacky or soft at room temperature but it should flow on demand at low temperature (above room temperature) and should be cured in range of maximum compatibility temperature with longer times or within compatibility of maximum temperature with radiation for much shorter times of seconds and minutes rather than hours as required for many industry available materials if using temperature only to cure. The low temperature adhesive bond material has an adhesion strength of less than about 10 Newtons/square centimeter (N/cm²) before curing, and has an adhesion strength of at least 40 N/cm² after curing. The bond material is used for temporary attachment of a device wafer to a handle by coating the bond material onto a carrying surface of the wafer or a carrying surface of the handle, then holding the coated carrying surface against the other carrying surface while curing the bond material by exposure to radiation at low temperature. After-cure adhesion strength in excess of 50 N/cm² may not be needed for many applications but can be acceptable for temporary bonding and debonding provided the device wafer can withstand debonding forces in applications of temporary attachment.

Adhesion strength in this case is measured by a “shear detachment” test. A rectangular silicon blank of a known area, e.g., 10×20 centimeters (cm), is attached to a glass handle using the low temperature adhesive bond material. Then blocks of aluminum are glued to the outer surfaces of the silicon blank and of the glass handle, using a known strong glue, e.g., a two part epoxy. The glued assembly is placed in a Instron using an appropriate jig and each aluminum block is ‘pushed’ until the silicon blank shears off the glass handle at the joint formed by the low temperature adhesive bond material. The push force required for shear detachment is measured in Newtons (N), and the adhesion strength of the bond material is measured as the ratio of push force to area of the blank in N/cm².

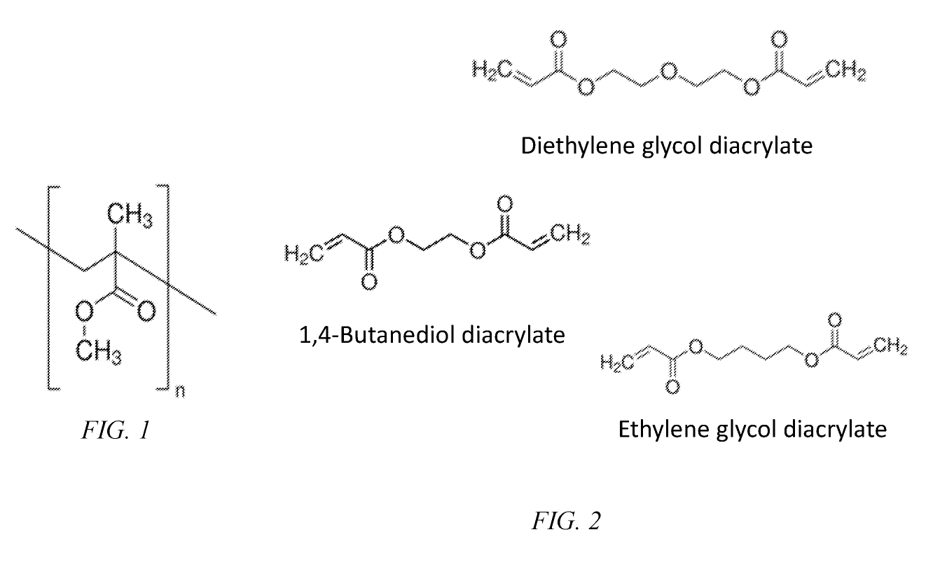

The cure properties of the low temperature adhesive bond material are obtained by combining two polymers into the one material composition: a suspended polymer and a diluent polymer. The suspended polymer is a thermoplastic resin with glass transition temperature (Tg) above room temperature, while the diluent polymer is a thermoset resin that cures under exposure to x-ray, ultraviolet, or visible light radiation at low temperature (above room temperature). For example, in one or more embodiments the suspended polymer is a polymethylmethacrylate resin (as shown in FIG. 1) with weight-average molecular weight in a range from approximately 30,000 Daltons to about 180,000 Daltons. In one or more embodiments, the diluent polymer is a difunctional acrylate or methacrylate, for example, a thermoset resin selected from the group consisting of ethyleneglycol diacrylate, butanediol diacrylate, and diethyleneglycol diacrylate as shown in FIG. 2.

The rolled tape can be used in a “reel-to-reel” process in which the tape is slit to a width appropriate for the device wafer. During reel processing the interleaf is removed in a continuous fashion and the device is positioned onto the adhesive side and laminated via a low temp heating or just ‘stuck’ to the pressure sensitive adhesive with pressure. The adhesive is then cured, so as to immobilize the device onto the tape via UV or UV+heat (low enough temperature so as not to damage device). The tape can now be used as a handle for the device wafer such as in cutting and stacking or cutting and place-for-packing.

Further embodiments of the invention combine the low temperature adhesive bond material with a release agent that can be ablated by exposure to radiation at low temperature. In one or more embodiments, the release agent can be ablated by exposure to radiation at room temperature.

In one or more embodiments, the low temperature adhesive bond material includes a release agent, such as carbon black and/or Gilsonite. In other embodiments, the release agent is provided as a separate layer between the wafer and the bond material, or between the bond material and the handle.

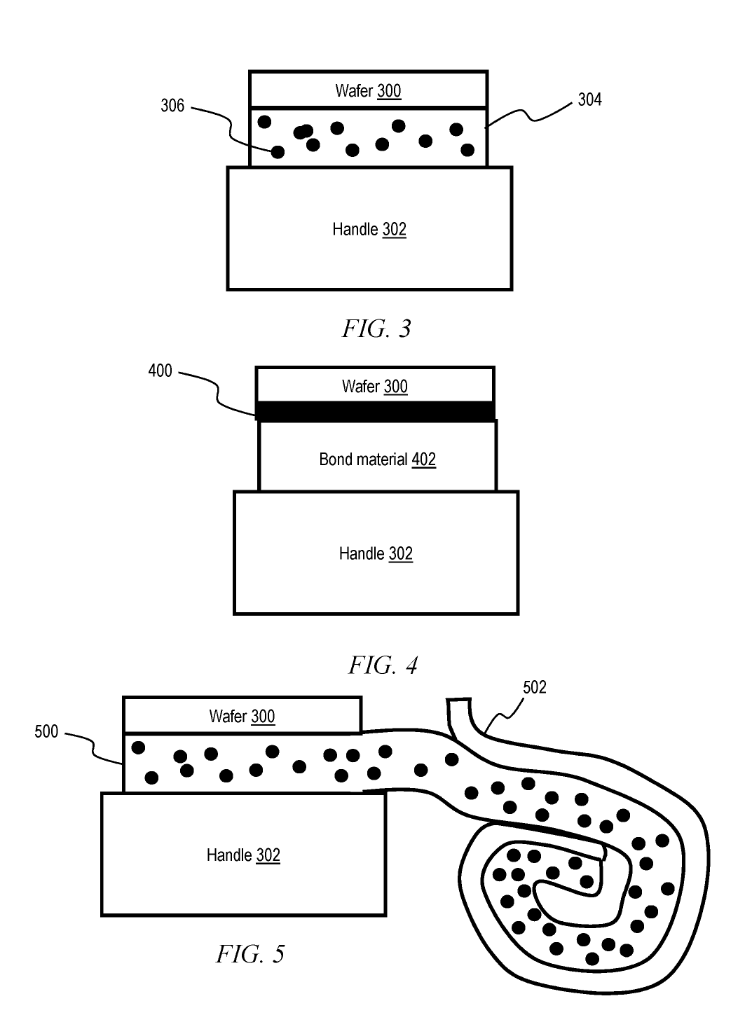

In one or more embodiments of the invention, as shown in FIG. 3, a wafer 300 is temporarily attached to a handle 302 by a layer of low temperature adhesive bond material 304 that incorporates a release agent 306. The wafer 300 typically is silicon, although other materials may be used. The handle 302 can be silicon, glass (e.g., fused quartz glass), or another material. Thus, the release agent is provided together with the low temperature adhesive bond material in a single layer that enables all in one spin on/bonding/curing. For a single layer, 3000 to 5000 nm thick, the bond material will substantially (>80%) transmit, and the release agent will substantially (>80%) absorb ultraviolet radiation from a 308 nm laser within the first 500 nm of the layer. This permits the release agent to be ablated for debonding of a silicon wafer from a glass handle by shining the laser through the glass handle onto the single layer at room temperature. Knowing use of a single layer for release and bonding can be an option, one could consider adding some level of higher absorption materials to an adhesive layer to release a variety of adhesives with only one layer that supports both bonding and release for some applications. This may be of interest where cost of spin on for two layers is sensitive and where level of radiation/exposure to release the layer is not damaging to the device wafer.

In one or more embodiments, as shown for example in FIG. 4, the release agent is provided as a separate release layer 400 that is coated onto a layer 402 of the bond material. The release layer 400 may be coated onto the surface of the bond material 402 that adjoins the wafer 300, or onto the surface of the bond material that adjoins the handle 302. Use of a thin release layer that is currently less than about 300-500 nanometers (nm) and that has high absorption at about 355 nm wavelength is suitable for use with glass handles that are essentially transparent to ultraviolet radiation emitted by a 355 nm solid state laser for room temperature debonding. Use of a thin release layer that is currently less than about 300-500 nm that has high absorption at about 1000-3000 nm is suitable for silicon handles that are essentially transparent to 1000-3000 nm infrared radiation emitted by a solid state laser for room temperature debonding. In each of the release layers currently used, the absorption of targeted radiation is typically >80%. In each of these cases different adhesives can be used with thickness between about 1000 nm to 20 um or thicker to meet different applications needs such as temperature compatibility, cure temperature and chemical resistance. Such adhesives are selected to permit removal by a conventional chemical clean process familiar to the ordinary skilled worker.

A suitable release agent ablates at room temperature or at low temperature under exposure to radiation, such as but not limited to a laser with 355 nm wavelength, 308 nm wavelength, other ultraviolet radiation, or generally, radiation of 256 nm to 512 nm wavelength, infrared radiation, or x-ray radiation. In one or more embodiments, at least one or more short pulses from less than 1 nanoseconds (ns) to 100 microseconds (us) at about 0.25 watts to 20 watts per 400 micron diameter circle area or about 200 micron diameter circle area for Full Width Half Maximum (FWHM) intensity of 355 nm ultra-violet radiation or about 1000 to 3000 nm infra-red radiation, was needed at room temperature in order to ablate the release agent sufficiently to reduce the adhesion strength between the wafer and the handle to less than about 10 N/cm². For example, using a solid state laser of about 6 watts maximum output and with laser operating at about 80% to 90% level where spot size is about 400 microns (um) and full width half maximum (FWHM) beam diameter is about 200 um, then for a release layer of about 0.2 to 0.3 um thickness the required energy density of the laser would be about 0.12 milliJoules (mJ) per pulse when operating at about 50 hertz frequency with a pulse of about 20 us and 12 ns pulse width. Based on the structure for Gilsonite, a lower power level per unit area, shorter pulse time and/or fewer pulses can be used to ablate the release layer at room temperature relative to other compositions of release layer evaluated with or without carbon additions. Further for those high carbon level release layers where uniformity in distribution of suitable release agent leads to poor stability or short time duration use times to keep the release agent adequately suspended prior to application to a wafer or handle wafer and/or prior to curing, the use of Gilsonite has shown to be effective to improve shelf life stability of the release layer.

After ablation of the release agent, residual release agent and bond material can be removed from the wafer by plasma ashing, oxygen ashing, and/or chemical cleaning.

In one or more embodiments, the bond material may be provided as a roll of tape 500, as shown in FIG. 5. The rolled tape material is a composition of suspended polymer and diluent polymer that has overall Tg just below room temperature so as to allow the material to be rolled without cracking. The tape 500 is rolled up with an interleaf material 502 to avoid self-sticking, then unrolled and laminated onto the handle 302, then the interleaf is removed to laminate to the device wafer. Exemplary interleaf materials will be apparent to the skilled worker in light of the materials specified for the low temperature bond adhesive and the release layer.

Given the discussion thus far, it will be appreciated that, in general terms, a device wafer can be bonded to a handle by a low temperature adhesive bond material that includes a suspended polymer with glass transition temperature greater than room temperature and a diluent polymer that is curable to provide a thermoset polymer upon exposure to ultraviolet radiation, x-ray radiation and/or thermal treatments at low temperature. The suspended polymer and the diluent polymer are mixed to a consistency such that before curing of the diluent polymer the low temperature adhesive bond material exhibits adhesion strength less than 10 Newtons per square centimeter (N/cm²), and after curing of the diluent polymer the low temperature adhesive bond material exhibits adhesion strength not less than about 40 N/cm².

In one or more embodiments, the handle is fused quartz glass and the diluent polymer is curable by ultraviolet radiation. In one or more embodiments, the low temperature adhesive bond material further comprises a release agent. In one or more embodiments, a layer of the release agent can be interposed between the low temperature adhesive bond material and one of the handle or the device wafer. In one or more embodiments, the release agent ablates at low temperature upon exposure to ultraviolet or x-ray radiation at an intensity of at least about 0.12 milliJoules (mJ) per FWHM 200 micron (um) diameter circle area.

In another aspect, an exemplary method includes coating a carrying surface of one of the device wafer or a handle with a low temperature adhesive bond material that includes a suspended polymer that has a glass transition temperature (Tg) greater than room temperature and a diluent polymer that is liquid at room temperature and is curable to provide a thermoset polymer upon exposure to ultraviolet radiation, x-ray radiation and/or thermal treatments at low temperature. The suspended polymer and the diluent polymer are mixed to a consistency such that before curing of the diluent polymer the low temperature adhesive bond material exhibits adhesion strength less than 10 Newtons per square centimeter (N/cm²), and after curing of the diluent polymer the low temperature adhesive bond material exhibits adhesion strength not less than about 40 N/cm². The method further includes, while holding the coated carrying surface against the carrying surface of the other of the device wafer or the handle, bonding the device wafer to the handle by irradiating the coated carrying surface with visible light, ultraviolet, or x-ray radiation at low temperature to cure the diluent polymer.

In one or more embodiments, the method further includes coating the low temperature adhesive bond material with a release agent. In one or more embodiments, the method further includes debonding the device wafer from the handle by irradiating the release agent with ultraviolet or x-ray radiation at an intensity of at least about 0.12 milliJoules (mJ) per FWHM 200 micron (um) diameter circle area.

In another aspect, a low temperature adhesive bond material includes a suspended polymer that has a glass transition temperature (Tg) greater than room temperature and a diluent polymer that is liquid at room temperature and is curable to provide a thermoset polymer upon exposure to ultraviolet radiation, x-ray radiation and/or thermal treatments at low temperature. The suspended polymer and the diluent polymer are mixed to a consistency such that before curing of the diluent polymer the low temperature adhesive bond material exhibits adhesion strength less than 10 Newtons per square centimeter (N/cm²), and after curing of the diluent polymer the low temperature adhesive bond material exhibits adhesion strength not less than about 40 N/cm².

In one or more embodiments, the suspended polymer is present in an amount between 10 and 50 weight percent and the diluent polymer is present in an amount between 90 and 50 weight percent. In one or more embodiments, the suspended polymer is a polymethylmethacrylate of weight-average molecular weight not less than 30,000 Dalton and not more than 180,000 Dalton. In one or more embodiments, the diluent polymer is a difunctional acrylate or methacrylate. For example, the diluent polymer is selected from the group consisting of: ethyleneglycol diacrylate, butanediol diacrylate, and diethyleneglycol diacrylate. In one or more embodiments, the low temperature adhesive bond material further includes a release agent that ablates at low temperature upon exposure to x-ray or ultraviolet radiation. In one or more embodiments, the release agent is selected from the group consisting of: Gilsonite and carbon black.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A low temperature adhesive bond material comprising:
a suspended polymer that has a glass transition temperature (Tg) greater than room temperature; and
a diluent polymer that is liquid at room temperature and that is curable to provide a thermoset polymer upon exposure to ultraviolet radiation, x-ray radiation and/or thermal treatments at low temperature;
wherein the suspended polymer and the diluent polymer are mixed to a consistency such that before curing of the diluent polymer the low temperature adhesive bond material exhibits adhesion strength less than 10 Newtons per square centimeter (N/cm²), wherein after curing of the diluent polymer the low temperature adhesive bond material exhibits adhesion strength not less than about 40 N/cm².

2. The material of claim 1, further comprising:
a release agent that ablates at low temperature upon exposure to x-ray or ultraviolet radiation.

3. The material of claim 2 wherein the release agent is selected from the group consisting of: Gilsonite and carbon black.

4. The material of claim 1 wherein the suspended polymer is a polymethylmethacrylate of weight-average molecular weight not less than 30,000 Dalton and not more than 180,000 Dalton.

5. The material of claim 4 wherein the diluent polymer is a difunctional acrylate or methacrylate.

6. The material of claim 5 wherein the diluent polymer is selected from the group consisting of: ethyleneglycol diacrylate, butanediol diacrylate, and diethyleneglycol diacrylate.

7. The material of claim 5 further comprising a release agent selected from the group consisting of: Gilsonite and carbon black.

8. The material of claim 7 wherein the suspended polymer is present in an amount between 10 and 50 weight percent and the diluent polymer is present in an amount between 90 and 50 weight percent.

9. A method for handling a device wafer, comprising:
coating a carrying surface of one of the device wafer or a handle with a low temperature adhesive bond material that comprises:
a suspended polymer that has a glass transition temperature (Tg) greater than room temperature; and
a diluent polymer that is liquid at room temperature and is curable to provide a thermoset polymer upon exposure to ultraviolet radiation, x-ray radiation and/or thermal treatments at low temperature;
wherein the suspended polymer and the diluent polymer are mixed to a consistency such that before curing of the diluent polymer the low temperature adhesive bond material exhibits adhesion strength less than 10 Newtons per square centimeter (N/cm²), wherein after curing of the diluent polymer the low temperature adhesive bond material exhibits adhesion strength not less than about 40 N/cm²; and
while holding the coated carrying surface against the carrying surface of the other of the device wafer or the handle, bonding the device wafer to the handle by irradiating the coated carrying surface with radiation at a first wavelength at low temperature to cure the diluent polymer.

10. The method of claim 9 wherein the low temperature adhesive bond material further comprises a release agent, the method further comprising:
debonding the device wafer from the handle by irradiating the carrying surface of the device wafer with ultraviolet or x-ray radiation at an intensity of at least about 0.12 milliJoules (mJ) per FWHM 200 micron (um) diameter circle area.

11. The method of claim 10 wherein the release agent is selected from the group consisting of: Gilsonite and carbon black.

12. The method of claim 9 further comprising:
before bonding the device wafer to the handle, coating the low temperature adhesive bond material with a release agent; and
debonding the device wafer from the handle by irradiating the release agent with ultraviolet or x-ray radiation at an intensity of about 0.12 milliJoules (mJ) per FWHM 200 micron (um) diameter circle area.

13. The method of claim 9 wherein the suspended polymer is a polymethylmethacrylate of weight-average molecular weight not less than 30,000 Dalton and not more than 180,000 Dalton.

14. The method of claim 9 wherein the diluent polymer is a difunctional or greater acrylate or methacrylate.

15. The method of claim 14 wherein the diluent polymer is selected from the group consisting of: ethyleneglycol diacrylate, butanediol diacrylate, and diethyleneglycol diacrylate.

16. The method of claim 15 wherein the suspended polymer is present in an amount between 10 and 50 weight percent, and the diluent polymer is present in an amount between 90 and 50 weight percent.

17. An apparatus comprising:
a device wafer;
a handle; and
a low temperature adhesive bond material bonding a carrying surface of the device wafer to a carrying surface of the handle, wherein the low temperature adhesive bond material comprises:
a suspended polymer with glass transition temperature greater than room temperature; and
a diluent polymer that is curable to provide a thermoset polymer upon exposure to ultraviolet radiation, x-ray radiation and/or thermal treatments at low temperature;
wherein the suspended polymer and the diluent polymer are mixed to a consistency such that before curing of the diluent polymer the low temperature adhesive bond material exhibits adhesion strength less than 10 Newtons per square centimeter (N/cm²), wherein after curing of the diluent polymer the low temperature adhesive bond material exhibits adhesion strength not less than about 40 N/cm².

18. The apparatus of claim 17 wherein the low temperature adhesive bond material further comprises a release agent that ablates at low temperature upon exposure to ultraviolet or x-ray radiation at an intensity of at least about 0.12 milliJoules (mJ) per FWHM 200 micron (um) diameter circle area.

19. The apparatus of claim 17 further comprising:
between the low temperature adhesive bond material and one of the carrying surfaces, a layer of a release agent that ablates at low temperature upon exposure to ultraviolet or x-ray radiation at an intensity of at least about 0.12 milliJoules (mJ) per FWHM 200 micron (um) diameter circle area.

20. The apparatus of claim 17 wherein the handle is fused quartz glass and the diluent polymer is curable by ultraviolet radiation.
